(19) United States
(12) Patent Application Publication
(10) Pub. No.: US 2008/0027894 A1
(43) Pub. Date: Jan. 31, 2008

(54) File system alteration of media files

(75) Inventors: Donald Molaro, Cupertino, CA (US); Jorge Campello De Souza, Cupertino, CA (US); Richard New, San Jose, CA (US)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., Amsterdam (NL)

(21) Appl. No.: 11/493,217

(22) Filed: Jul. 25, 2006

(51) Int. Cl. G06F 17/30

(52) U.S. Cl. 707/1

(57) ABSTRACT

Embodiments of the invention provide a file system that can store files or data streams in such a manner as to increase the effective storage capacity of the device on which the files or data stream are stored. In one embodiment, a system for processing and storing data comprises a first processing module configured to receive data directed to the system, the data comprising a first portion and a second portion; a second processing module configured to store the first portion of the data within a data storage device and remove the second portion of the data; a third processing module configured to retrieve the first portion of the data from the data storage device, the first portion of the data being combined with filler data to form reconstituted data; and a fourth processing module configured to send the reconstituted data to an output device.

### CROSS-REFERENCES TO RELATED APPLICATIONS

NOT APPLICABLE

### BACKGROUND OF THE INVENTION

This invention relates generally to file systems used in conjunction with data storage devices and methods of optimizing capacity. More particularly, the invention provides a file system that can store files or data streams in such a manner as to increase the effective storage capacity of the device on which the files or data streams are being stored.

The use of hard disk drives and other data storage devices has become increasingly widespread with the advent of recent technological improvements. While once almost exclusively used in the realm of computing, data storage devices can be found in digital music players, game consoles, TV console boxes, and other electronic host devices to provide a reliable and effective location for data storage. Data storage devices are particularly effective for storing different forms of media, such as music, electronic games, or videos, where the data storage device can be used to store a plethora of media files.

One significant problem that can occur with the increasingly common storage of media files within data storage devices is that device storage capacities are frequently insufficient for consumer demand. The increasing size of large media files such as the high-definition (HD) TV, digital movies, and music files means that the media files may occupy an increasingly large percentage of the storage space within the data storage device. Once the storage capacity of the storage device has been met, the user may be forced to remove stored data from the storage device to allow the host device to continue to store new files. One method of increasing storage available within the host device is to replace the data storage device with a device of larger capacity. However, this may require additional expenditure on the user's part, may require technical skills that the average user does not possess, or may violate the device's terms of use.

Despite the availability of the above-described techniques for increasing storage capacity, new devices and methods for increasing the capacity of a data storage device are desired.

### BRIEF SUMMARY OF THE INVENTION

Embodiments of the invention provide a file system that can store files or data streams in such a manner as to increase the effective storage capacity of the device on which the files or data stream are stored. In specific embodiments, unneeded or unrelated portions of the received file or data stream are removed by the file system and only a portion of the received file or data stream is stored. During playback, filler data may be inserted into the stored data or transfer stream to reach a standardized bit rate of transmission. However, it would be recognized that the invention has a much broader range of applicability.

In accordance with an aspect of the present invention, a system for processing and storing data comprises a first processing module configured to receive data directed to the system, the data comprising a first portion and a second portion; a second processing module configured to store the first portion of the data within a data storage device and remove the second portion of the data; a third processing module configured to retrieve the first portion of the data from the data storage device, the first portion of the data being combined with filler data to form reconstituted data; and a fourth processing module configured to send the reconstituted data to an output device.

In some embodiments, the data and the reconstituted data have identical file sizes. The data and the reconstituted data may have identical data transfer rates. The data possibly in the format of an MPEG transport stream. The system includes a module that determines which portions of the transport stream to store based on packet identifier data of the individual packets within the transport stream. The filler data is located within packets that are identifiable based on the packet identifier data of the packets. The filler data may be NULL data or other data that is not related to the desired content. The fourth processing module is configured to send the first portion of the data without the second portion of the data from the data storage device to the output device. The data storage device may be a hard disk drive or any other computer compatible storage device.

In specific embodiments, a data storage system comprises a hard disk drive and the system for processing and storing data. The hard disk drive is the data storage device. The hard disk drive includes one or more of the first processing module, second processing module, third processing module, and fourth processing module. The data storage system may be a personal video recorder (PVR) device. The system for processing and storing data may be implemented in a host device used for media applications. A host device controller is configured to enable read/write access to the data storage device, the host device controller further configured to receive data stored on the data storage device and transmit the data to an output device connected or integrated with the host device. A communication bus is configured to allow data to be transferred between the device controller and the storage device.

In accordance with another aspect of the invention, a file system for processing and storing content files comprises a first processing module configured to receive a content file in a first format directed to the file system, the content file comprising requested and unrequested portions of the content file; a second processing module configured to store the requested portion of the content file in a second format within a data storage device and remove the unrequested portion of the content file; a third processing module configured to retrieve the requested portion of the content file from the data storage device; the requested portion of the content file being retrieved in the second format; and a fourth processing module configured to send the requested portion of the content file to an output device.

In some embodiments, the third processing module is further configured to retrieve the requested portion of the content file in the first format from the data storage device, the unrequested portion of the content file being replaced by NULL data.

In accordance with another aspect of the invention, a computer readable storage medium stores a computer program in a system for processing and storing data. The computer program comprises code for receiving data in a first format directed to the system, the data comprising a first portion and a second portion; code for storing the first portion of the data within a data storage device and removing a second portion of the data; and code for retrieving the first portion of the data from the data storage device, the first portion of the data being combined with filler data to form reconstituted data.

### BRIEF DESCRIPTION OF THE DRAWINGS

FIG. 1 is a simplified exemplary diagram showing the user representation and storage representation of data being stored according to an embodiment of the present invention;

FIG. 2 is a simplified exemplary diagram showing a process of storing analog television onto a data storage device using a conventional method;

FIGS. 3 and 4 are simplified exemplary diagrams showing a transport stream and its contents;

FIG. 5 is a simplified exemplary process flow showing a file system alteration process performed on a media stream according to an embodiment of the present invention;

FIGS. 6-8 are simplified exemplary diagrams showing processes relating to storage and playback of digital television signals according to embodiments of the present invention;

FIG. 9 is a simplified exemplary diagram showing playback and storage of media streams according to an embodiment of the present invention;

FIG. 10 is a simplified exemplary diagram showing a “black box” representation of the file system according to an embodiment of the present invention; and

FIG. 11 is a simplified exemplary diagram of a file system according to an embodiment of the present invention;

FIG. 12 is an exemplary simplified perspective view of a hard disk drive (HDD) that can be used as a data storage device according to an embodiment of the present invention; and

FIG. 13 is an exemplary simplified functional block diagram of the HDD according to an embodiment of the present invention.

### DETAILED DESCRIPTION OF THE INVENTION

One common assumption made in regard to the storage of data is that the bits being stored into a data storage system must equal, both in quantity and value, the bits when the data is retrieved from the data storage system. A difference in the bits before and after storage of the data can be caused by a portion of the data being lost or altered during storage or retrieval. This can indicate incomplete or improper storage of the data being stored.

However, for certain types of data such as video or media data, maintaining the exact size and value of the data being stored is not as important as maintaining the “experience” that the data represents. For example, from a qualitative point of view, the music stored on a compact disk or CD is nearly the same as that stored in alternative formats, such as PCM, MP3, WAV, or others, yet the size and value of the data in all of these alternatives are not the same. A similar example can be made for video files, in that video files stored in an MPEG 2 format, in a Windows Media format, or other format may all represent a similar experience to the user regardless of the format. Of course, there may be slight differences in the audiovisual quality between different file formats for the data, but the exact file format employed is suitable so long as it is able to convey the appropriate “experience” to the user.

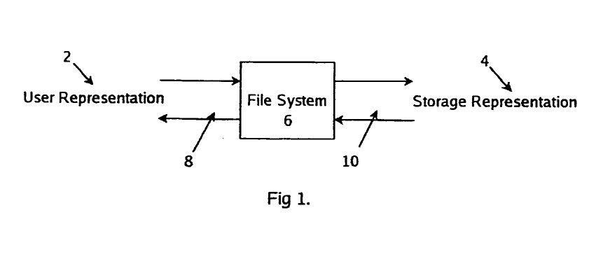

From the perspective of the storage system, however, the data is merely a sequence of bits to be stored for future retrieval. The data is stored within the appropriate data storage medium without regard for the kind of file being stored, be it media, video, text, or otherwise. In one embodiment of the invention, the user representation and storage representation of the same data are modified so that the data may be replayed in an equivalent format that occupies less storage capacity. For example, FIG. 1 is a simplified exemplary diagram of showing the user representation and storage representation of data being stored according to an embodiment of the present invention. The user stores their content on the data storage system (FIG. 1) without regard for the exact format of the file being stored on the data storage system, trusting that the file system 6 will appropriately store the user's representation 2 of the content and appropriately retrieve that representation upon a request for the content. The user representation of the content is not the specific file being stored, but what the experience that the content represents, be it a music song, video, or other representation. The content file itself is passed into and out of the file system 6 through communication mediums 8 and 10, which may be physical bus connections or wireless transfer protocols. The file system 6 may perform one or more alterations on the content being stored, so that the content is stored in an equivalent, but not identical storage representation 4. In a specific embodiment of the invention, the alteration performed on the content is done in a lossless manner, so that an exact reproduction of the data stored may be created. In another specific embodiment of the invention, the alteration performed on the content is done in a lossy manner but in such a manner that the data can still provide the same entertainment experience. Upon a request for the content from the user, the storage representation of the content is returned through the file system 6 and may undergo one or more alterations in the file system 6 before being replayed as the user representation 2 of the content.

The storage system described in FIG. 1 can optimize storage for a variety of different formats but may optimally be used for media content, such as audio or video files. Other kinds of files that may additionally be suitable for alteration are those in which data are reused or repeated within the file, allowing for an improved storage representation of the file while providing the file to the user in an equivalent format. The storage system (FIG. 1.) may be used in a personal video recorder (PVR) type device or other consumer electronic devices, in which the PVR is connected to cable, satellite, or broadcast network.

Recent technological developments have increased the adoption of high-definition television (HDTV) over standard TV formats such as PAL and NTSC. HDTV provides a higher resolution than standard definition TV formats and has become increasingly more common as consumers opt for higher-quality broadcasts. HDTV may be broadcast using the MPEG-2 standard, which is a standard for compressing sound and movie files into an attractive format for delivery; in the MPEG-2 format, a properly compressed video can be shown at near-theatre clarity with surround sound, and may be used in digital televisions, DVD videos, and SVCDs.

The MPEG-2 standard allows for two different types of multiplexing: transmission through as an MPEG program stream or as an MPEG transport stream. The program stream form of multiplexing is suited for transmission in a relatively error-free environment and enables easy software processing of the received data by tightly coupling a group of packetised elementary stream (PES) packets referenced to the same time base. In comparison, the transport stream method of multiplexing separates larger packetised elementary stream (PES) packets into packets of a fixed-size to form a general method of combining one or more streams, possibly with independent time bases. By doing so, the transport stream may be more suited for transmission in which there may be potential packet loss or noise corruption, or when more than one program is sent at a time. For example, HDTV programming may be sent over using an MPEG-2 transport stream as a multiplexing protocol.

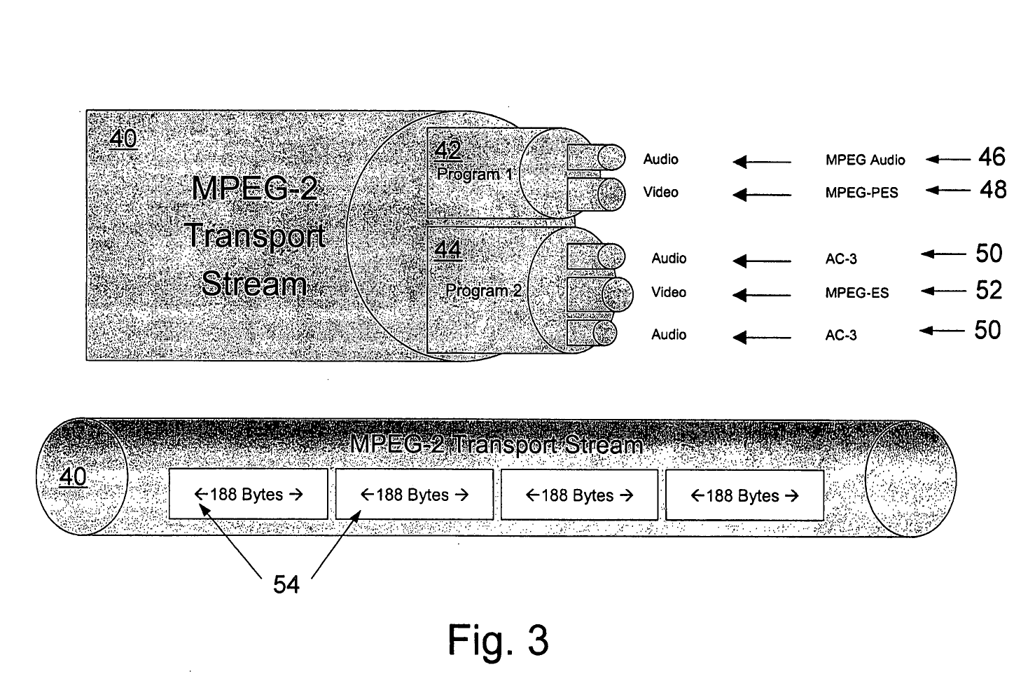

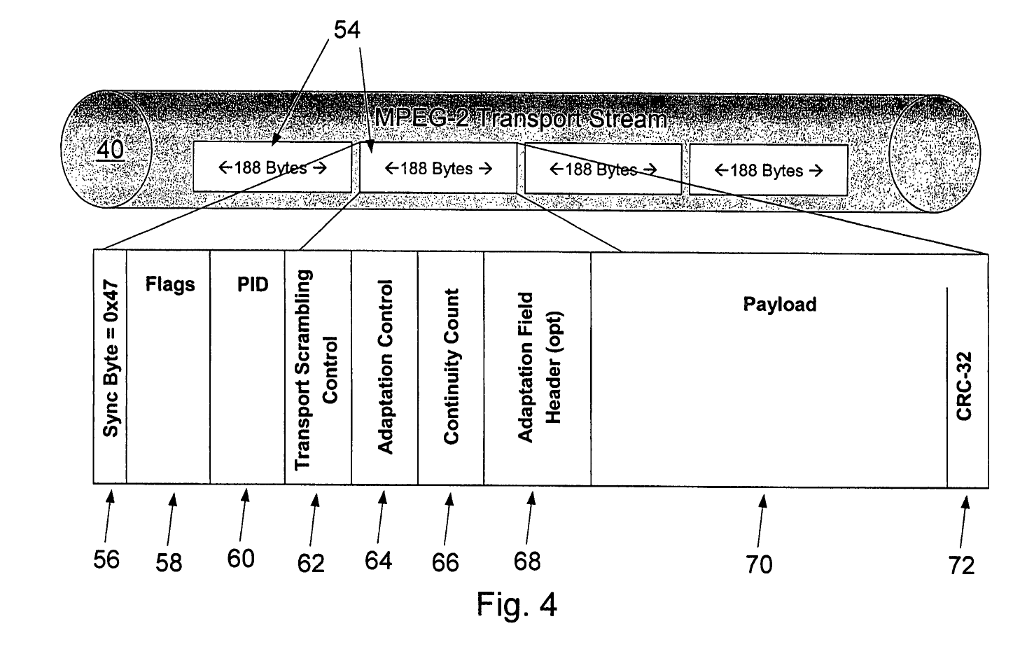

MPEG-2 transport streams may be sent using an Advanced Television Systems Committee (ATSC), ASI (Asynchronous Serial Interface) or other standard for use with digital television within the United States and other countries. FIGS. 3 and 4 are simplified exemplary diagrams showing a transport stream and its contents, which may be transmitted using an ATSC standard. The MPEG-2 transport stream 40 may transmit one or more programs/data simultaneously within the bandwidth offered by the transport stream, and may contain a significant amount of “extra” data in addition to the audio/visual components being sent to the user. The MPEG-2 transport stream 40 may comprise one or more elementary streams that contain a single type of signal, which may be digital audio, digital video, digital data, or digital control data. For example, a broadcast ATSC transport stream transports data at precisely 19.39 megabytes/second (Mb/sec). Broadcasting a transport stream at a lower data transfer rate will not comply with the ATSC standard. A single HDTV program, such as Program 1 (42), is normally encoded at a bit rate of 11-13 Mb/sec, and may contain the audio 46 and video 48 elementary streams associated with the program. Therefore the transport stream 40 would contain 6-8 Mb/sec of irrelevant or NULL data to be included for the purposes of playback of the transport stream 40. The additional data being transmitted may be low resolution versions of the high-definition program broadcast inside the transport stream, or other unrelated content may be present such as digital radio broadcasts or unrelated video programs. For example, Program 2 (44) is also being transmitted within the transport stream 40, and may be a low resolution version of the high definition broadcast or another unrelated program altogether. Program 2 also contains audio content 50 in the form of AC-3 coded transmissions in an elementary stream and video content as an MPEG elementary stream.

The MPEG-2 transport stream 40 is itself made up of a series of packets 54 multiplexed together. The packets 54 possess a fixed-length packet structure of 188 bytes, but other packet sizes could also be used. The packet length chosen may be the result of a compromise in that the longer the packet, the less overhead is present in the form of headers and sync data. Conversely, the shorter the packet, the easier it may be to synchronize the stream of packets upon receipt. In addition, the constant packet length makes error recovery and synchronization of the streams easier in comparison to variable packet lengths. FIG. 4 further details the breakdown of the packet contents for one of the packets within the transport stream 40. A packet 54 is made up of a header (56-68), a payload 70, and cyclic redundancy check (CRC) data used for error checking and recovery 72. The header 56-68 normally occupies a small percentage of the total size of the packet and may be 4 bytes of the 188 bytes in an exemplary embodiment. The header is used for a variety of purposes including synchronization with the other packets in the packet stream, identification of the individual packets, and flags indicating information about the specific packet. The Packet Identifier (PID) 60 is used, for example, to identify packets being sent within different streams. For example, packets relating to video for one program may have a first PID, sound relating to the same program having a second PID, and video relating to a third program having a third PID. By identifying the PID associated with each packet, it is possible to determine which elementary stream with which the packet is associated. This allows the receiver of the transport stream 40 to reconstruct and resynchronize the component elementary streams within the transport stream 40 to enable playback of the desired media. The payload 70 is the bulk of the size transport file and is the actual data being transported to the receiver, as opposed to the control information located within the header 56-68.

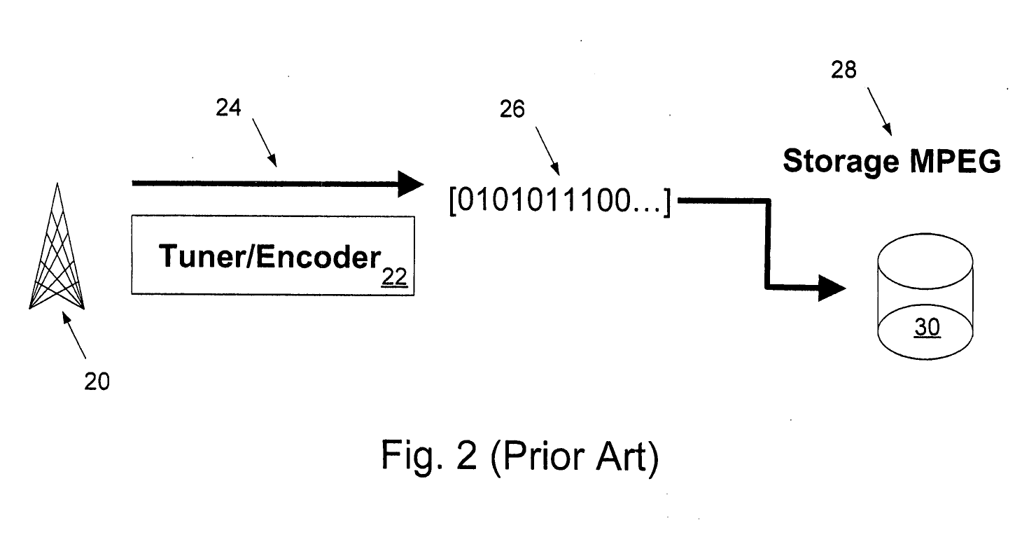

One type of data that may be stored within a storage system such as a PVR device are television signals broadcast over the airwaves. The television signal may be analog or digital, depending upon the signal being received. FIG. 2 is a simplified exemplary diagram showing a process of storing television onto a data storage device using a conventional method. An analog or digital television signal 24 is broadcast from a signal tower 20 through the airwaves to homes within the vicinity of the broadcast. For example, if a digital television signal is being broadcast, it may be sent as a transport stream as described in FIGS. 3 and 4. A television (not shown) may be used to receive the broadcast, but the user may want to record the broadcast for future viewing using a personal video recorder (PVR) device or other recording device. One component of the personal video recorder or television is the tuner/encoder card 22, which receives the signal 24 and, if necessary, encodes the signal 24 into a digital signal 26 or a series of bits. The digital signal 26 is stored as a digital program (storage MPEG) 28 on the data storage device 30.

In the storage process shown in FIG. 2, the entire transport stream or signal 24 is stored, regardless of whether or not unrelated content is additionally stored within the transport stream. This may be done for a number of reasons; for example, it can simplify the software architecture being used and reduce the chance of failure by not performing any additional processing of the transport stream 24. However, storing the entire transport stream 24 takes up additional space within the data storage device 30 as opposed to simply storing the requested content. Additionally, the rights of the copyright holder of the unrelated content may also be infringed, as the user may or may not be permitted to store and copy the unrelated sub streams accompanying the desired media content.

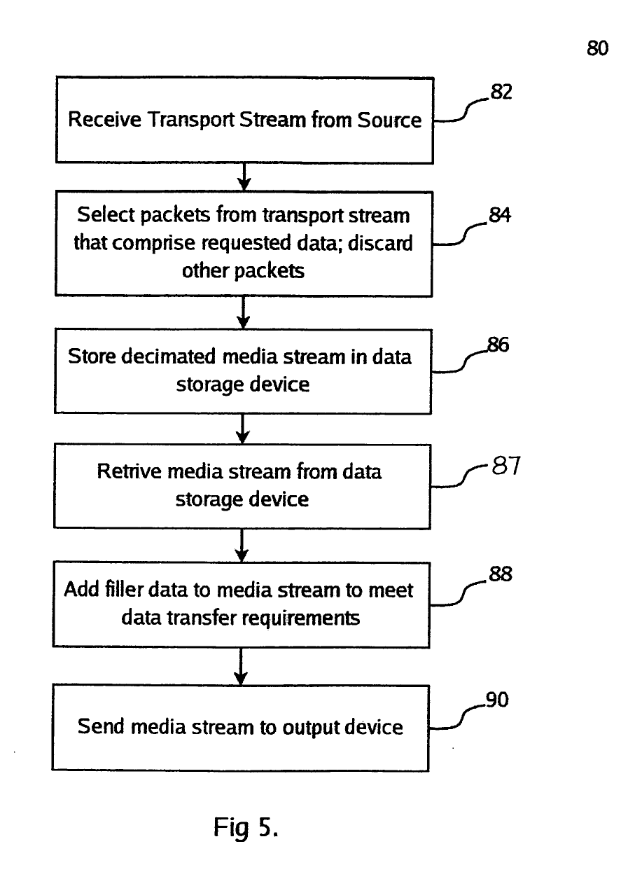

In comparison, FIG. 5 is a simplified exemplary process flow showing a file system alteration process performed on a media stream according to an embodiment of the present invention. The process flow 80 includes a process 82 for receiving the transport stream from the source; a process 84 for selecting the packets from the transport stream that make up the requested data, while discarding the other packets; a process 86 for storing the media stream within the data storage device; a process 87 for retrieving the media stream from the data storage device; a process 88 for adding filler data to the media stream to meet data transfer requirements; and a process 90 for sending the reconstituted data to an output device. The computation required for these processes may be performed in real time.

In process 82, the transport stream is received from the source, which may be a signal tower, satellite, or other broadcasting source. The transport stream may be an ATSC transport stream as described in FIGS. 3 and 4, and may contain additional programs or content other than the requested program. The transport stream may additionally be received by a television, PVR device, or other device capable of receiving the signal and transferred to a file system within the device.

In process 84, packets are selected from the transport stream which contains the requested data. The other packets within the transport stream which may be unrelated content or NULL packets are then discarded. In a specific embodiment, the packets may be selected by identifying each packet based on its PID value in its header. For example, storage of a HDTV program could be accomplished by selecting the appropriate packets within the transport stream with the PID value corresponding to audio and video packets for the program. The requested data may be a program or media content selected by the user for recording or the data may be recorded by a PVR device without human intervention. The selection process may be implemented by a human user or within hardware or software. A physical process of selecting the appropriate channel or desired media content may not need to be performed. For example, a PVR or other device may also “select” a file or transport stream for viewing or storage of the transmission.

The data storage system may additionally process data based upon the format of the data being stored and may take appropriate actions based upon the format. Files that are not identified as a transport stream or similar media format can be stored in an unmodified format. Conversely, files that are identified as a transport stream or similar media format may be processed accordingly.

The resulting decimated stream can be stored within a data storage device in process 86. Only the required portions necessary to reconstruct the desired media stream are stored, as unnecessary or filler data can be removed to optimize storage capacity. For example, storage of a transport stream using a conventional method stores the entire stream at a transmission rate of 19.39 Mb/sec. However, the component media stream is typically encoded at 11-13 MB/sec, allowing for an increased storage efficiencies of between about 30-50%. Of course, the percentage of storage efficiency gained may change depending on the file type and protocol being stored. The increased storage efficiency may additionally allow the storage system to have more value within an overall system such as a PVR device. The media stream is retrieved from the data storage device in process 87, and filler data is added to the media stream to meet data transfer requirements in process 88.

Depending upon the application, the media stream may be directly transmitted to a decoder for output to an output device in process 90. The media stream may pass through the decoder to ensure that the elementary streams within the media stream are coordinated or synchronized to ensure that the audio playback is synchronized with the corresponding video playback. However, one drawback to this method is that the decoder and other application programs may have to be modified to accommodate for differing output sizes of the media stream. Alternatively, filler data can be added to the transport stream to pad the retrieved stream with additional packets such that the resulting transport stream fills the required bandwidth. For example, to create an ATSC-compliant transport stream, a media stream can be filled with sufficient filler data to achieve a transmission rate of 19.39 Mb/sec. In a specific embodiment of the invention, the filler data may be NULL packets containing no data in the payload of the packet. NULL or filler packets may be easily identified within the header of the packet, making playback of the reconstituted stream robust and efficient.

In another embodiment of the invention, the decimated media stream may be processed in a lossy manner to further optimize the storage capacity of the device. The data stored into the system may be different from the data retrieved from the system so long as the data stored within the system can be used to create a substantially similar user experience as the original data. For example, the data being stored into the system may be an uncompressed audio stream of a large size. Following the decimation of the audio stream, the audio stream may be further processed into a second audio format that is of a significantly smaller size but provides a comparable audio experience. Filler data may be added to the decimated media stream after it has been processed to meet data transfer requirements, as described previously.

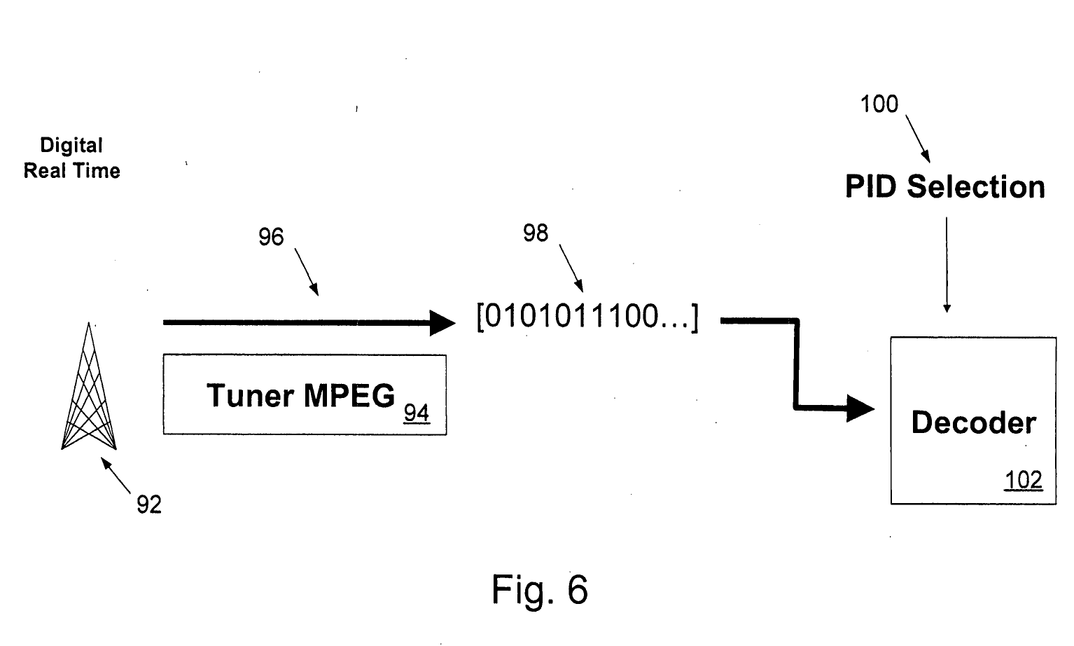

The process flow of FIG. 5 may be better understood in reference to FIGS. 6-8, which are simplified exemplary diagrams showing processes relating to storage and playback of digital television signals according to embodiments of the present invention. FIG. 6 is a simplified exemplary diagram showing a process relating to the viewing of digital television signals according to an embodiment of the present invention. A digital television signal 96 is broadcast from a signal tower 92 to areas within the vicinity of the broadcast. For example, the digital television signal may be an ATSC transport stream as described in FIGS. 3 and 4, and may contain additional programs or content other than the desired program to be stored Of course, alternative methods of transmitting the transport stream could also be used, for example through cable, fiber, or satellite networks. A television (not shown) may be used to receive the broadcast, but the user may want to record the broadcast for future viewing using a personal video recorder (PVR) device or other recording device. The transport stream is received through the television or receiver device through a tuner MPEG card 94 as a sequence of bits 98. With the input of the PID selection 100, the sequence of bits 98 passes through decoder 102 and the appropriate packets within the media streams contained in bit sequence 98 are selected and synchronized for viewing in real time.

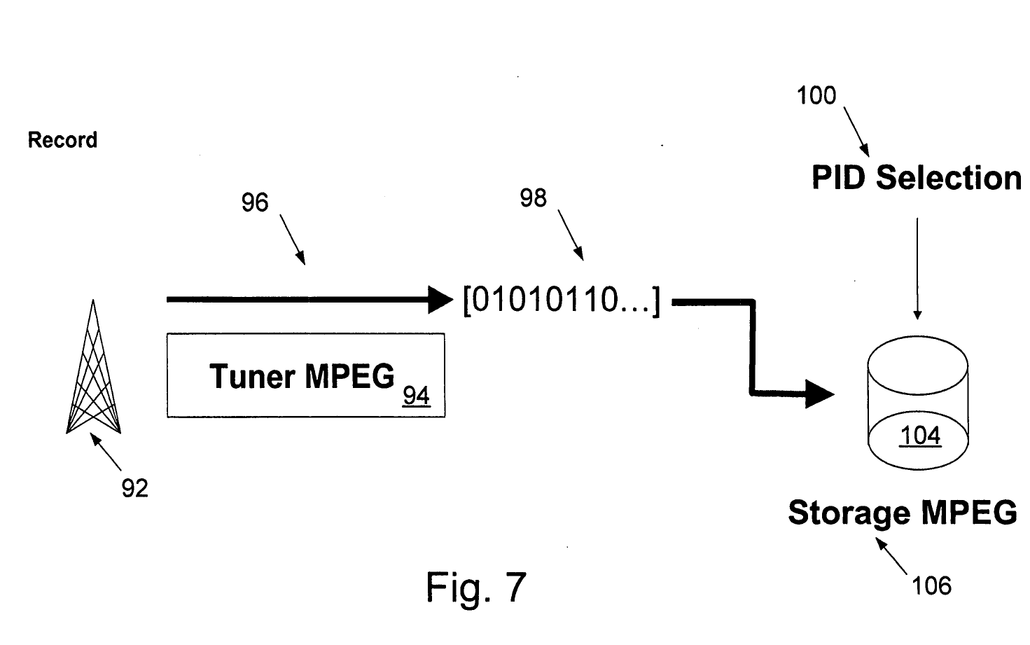

FIG. 7 is a simplified exemplary diagram showing a process relating to the storing of digital television signals according to an embodiment of the present invention. A digital television signal is broadcast from the signal tower 92 and passes through the tuner card 94 similar to FIG. 6. The sequence of bits 98 is then stored within the storage device 104, depending upon the PID selection 100. With the input of the PID selection 100, the appropriate packets within the media streams contained in the bit sequence 98 are selected and stored as a media stream. For example, the selected program may be stored as a storage MPEG 106.

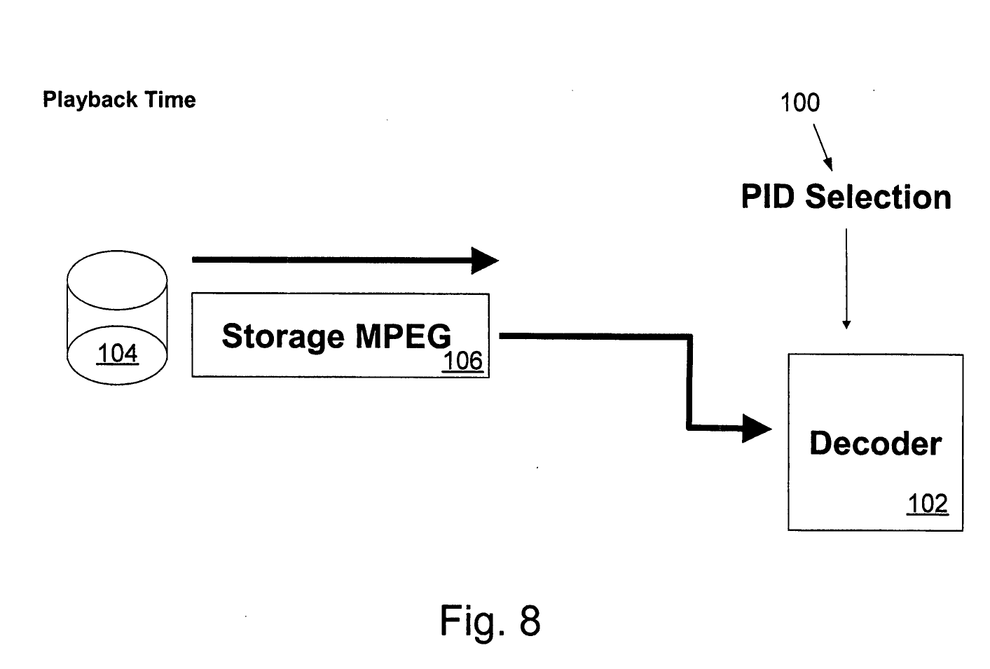

FIG. 8 is a simplified exemplary diagram showing a process relating to the playback of digital television signals according to an embodiment of the present invention. The storage MPEG 106 is output from the storage device 104, and passes through the decoder 102 to be sent to an output device (not shown). Padding and insertion of filler data may be performed after or before decoding, depending upon the specific implementation used. The PID selection 100 may be used to assist in the selection of the audio and video elementary streams within the storage MPEG 106 for decoding and synchronization.

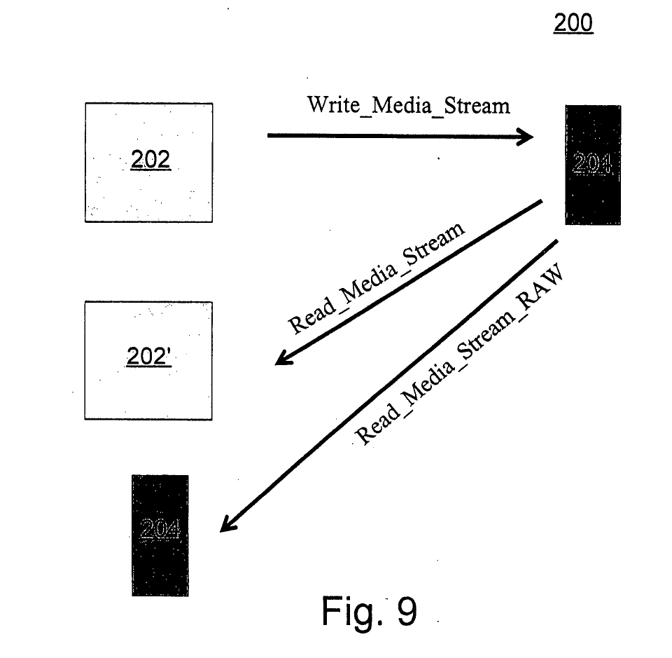

FIG. 9 is a simplified exemplary diagram showing playback and storage of media streams according to an embodiment of the present invention. In a storage systems implementation 200, a media stream 202 is written to a data storage device as a decimated media stream 204. The media stream 202 could be a MPEG transport stream containing unrelated data, or NULL packets, in addition to the desired media content. The media stream is thus converted from a high bandwidth representation to a lower bandwidth, but equivalent representation during the writing process. The decimation process removes unrelated content from the original media stream, as described in reference to FIG. 5. Having stored the media stream within a data storage device, two options are available for the retrieval of the media stream. First, the media stream can be retrieved as a equivalent bit rate version in which the system inflates the modified media stream 204 from a low bandwidth representation back to a high bandwidth representation 202′ which provides the same content as the original media but with different unrelated or filler data to replace the removed data. Alternatively, the decimated or lower bit rate representation can be retrieved. 204.

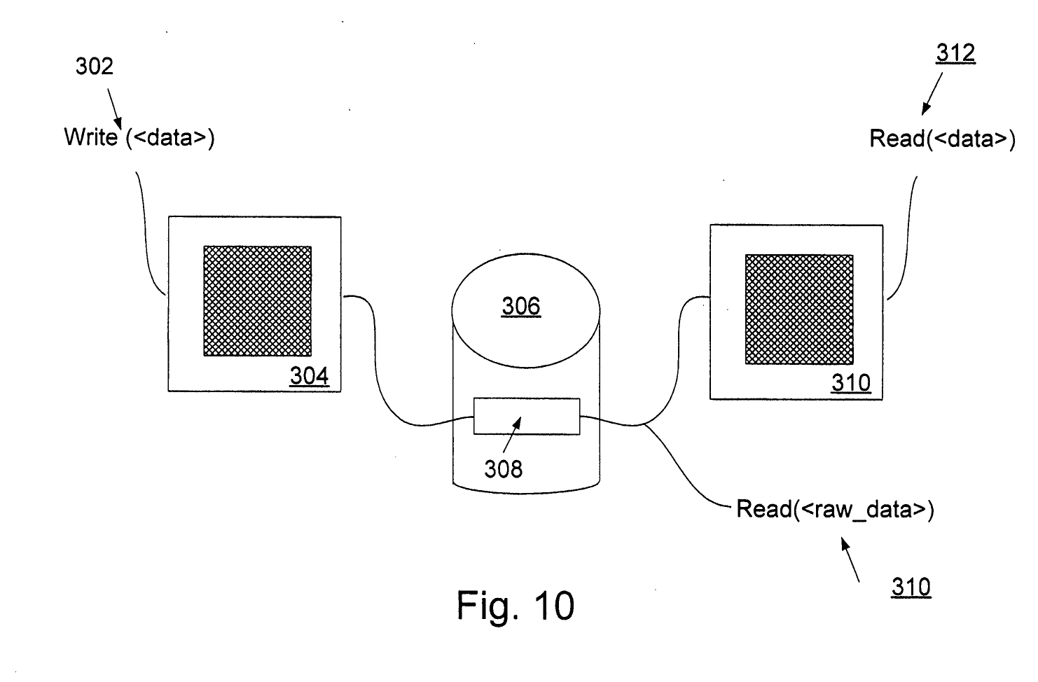

The data storage and alteration processes described in embodiments of the present invention may be generalized as occurring within a file system. For example, the processes described in FIG. 5 may be performed within a file system, as shown in FIG. 10. FIG. 10 is a simplified exemplary diagram showing a “black box” representation of the file system according to an embodiment of the present invention. A data writing process 302 writes data or a media stream into a “black box” system 304, where one or more operations is performed upon the data. For example, one of the operations may be to decimate the data from a high bandwidth representation to a low bandwidth representation by removing any unrelated content from the media stream. The system 304 then stores the processed data 308 within the data storage device 306. The processed data may be stored as a media stream or other compatible format. In addition, the number of bits that the within the processed data 308 need not equal the number of bits of data prior to the write process 302. When a request for the processed data 308 is received, the data may be retrieved in two formats. First, the data may be read through another “black box” system 310 by read process 312 where one or more operations is performed upon the processed data 308. For example, one of the operations performed may be to inflate the data from a low bandwidth representation to a high bandwidth representation by inserting filler data into the processed data to recreate the characteristics of the original data or media stream. Alternatively, the processed or raw data 308 may alternatively be provided to the user as a response to a “read raw_data” process 310. For example, the processed data may be a media stream of the audio and video packets comprising a requested program, without any unrelated content or filler data. An additional decoder may be needed to synchronize the raw data or media stream from the data storage device 306.

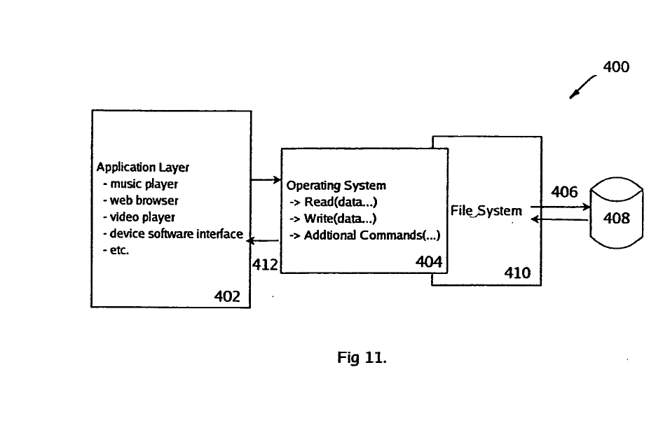

The placement and actual location of the file system as black boxes 304 and 310 may depend upon the specific implementation used. For example, FIG. 11 is a simplified exemplary diagram of a file system according to an embodiment of the present invention. Within the application layer 402 are programs such as a music player, video player, or other application and end user processes. Everything performed at this level is application-specific. The application layer 402 is connected to the file system 410, via the operating system 404, and through the file system to device drivers 406, and data storage device 408. Data is transferred from the application level 402 to the file system 410 and the operating system (OS) 404 when a storage or retrieval request is initiated. Read and write function calls 404 are executed at the OS level through the file system 410, to transfer data through device drivers 406 to data storage device 408.

Embodiments of the present invention may be implemented within any or all portions of the file system 410. For example, embodiments of the invention may be instantiated as one or more processing modules, wherein the processing modules are located within areas of the file system. The processing module may be implemented in hardware or software. For example, embodiments of the invention may be performed using processing modules solely at the operating system level, with specialized function calls used to store and alter the incoming data or media. Alternatively, embodiments of the invention may be performed using processing modules at the device driver level, with specialized device drivers used to store and alter the incoming data or media from the OS. In another example, embodiments of the invention may be performed using processing modules solely at the data storage device level, with specialized software or hardware implemented to enable file system alteration of the incoming data or media. A hardware-processing module such as a specialized media processor that can transcode media formats in real-time may be included into the data storage device. The processing modules may be spread across different areas of the file system, with a portion of the processing modules located in the OS/function call level, a portion of the processing modules located within the device driver level, and another portion of the processing modules located within the data storage device level. One of ordinary skill in the art would recognize many variations, alternatives, and modifications.

Other embodiments of the invention include updating of the portions of the file system relating to alteration of media files through firmware or software updates, which may be delivered to the PVR or other device through communication networks such as cable or satellite. Another embodiment of the invention includes the ability to override the file system alteration for media files or streams and resume normal storage functionality, where the number of bits in equals the number of bits out.

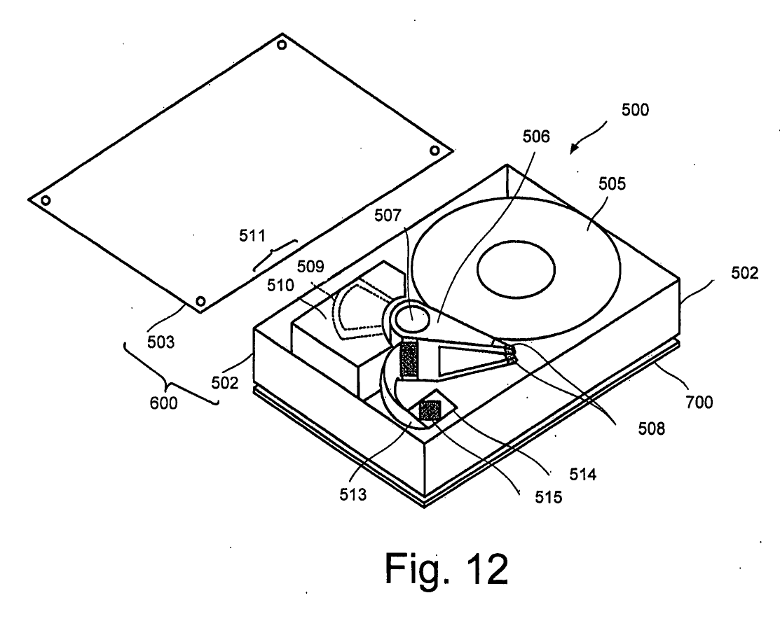

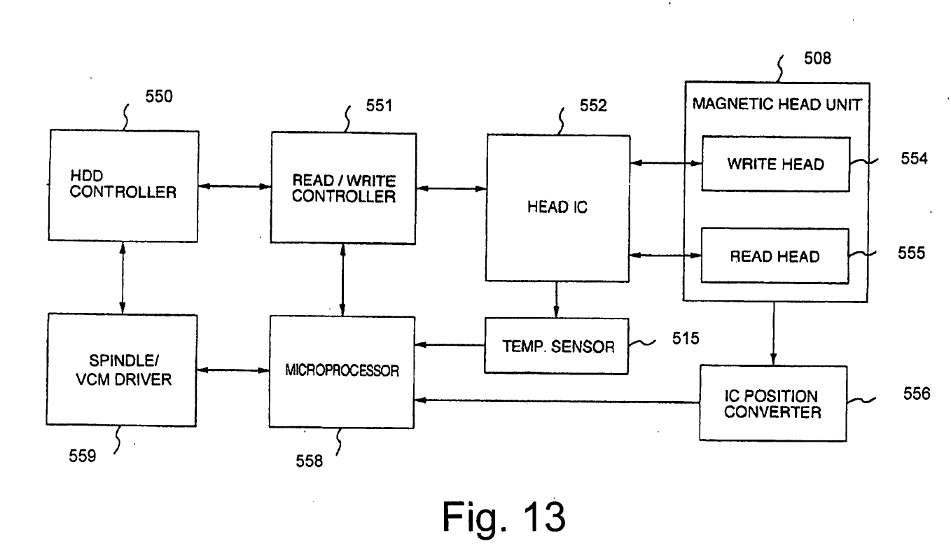

FIG. 12 is an exemplary simplified perspective view of a hard disk drive (HDD) that can be used as the data storage device according to an embodiment of the present invention. FIG. 13 is an exemplary simplified functional block diagram of the HDD according to an embodiment of the present invention. As shown in FIG. 12, the HDD 500 includes a disk enclosure 600 having a top cover 503 installed to seal the open top of a box-shaped base 502, which may be made, for instance, of an aluminum alloy. The top cover 503 is made, for instance, of stainless steel, and is fastened by fasteners to the base 502 with a sealing member (not shown), which is shaped like a rectangular frame. The disk enclosure 500 contains a spindle motor (not shown), which comprises, for instance, a hub-in, three-phase DC servo motor. The spindle motor imparts rotary drive to a magnetic disk 505, which is a storage medium. One or more units of the magnetic disk 105 are installed in compliance with the storage capacity requirements for the HDD 500. A card 700 is attached to the lower surface of base 502. The card 700 carries a signal processing circuit, a drive circuit for spindle motor, and other components described later.

An actuator arm 506 is mounted within the disk enclosure 600. The middle section of the actuator arm 506 is supported above the base 502 so that it can pivot on a pivot axis 507. A composite magnetic head 508 is mounted on one end of actuator arm 506. A VCM (voice coil motor) coil 509 is mounted on the remaining end of actuator arm 506. The VCM coil 509 and a stator 510, which is made of a permanent magnet and fastened to the disk enclosure 200, constitute a VCM 511. When a VCM current flows to the VCM coil 509, the actuator arm 506 can move to a specified position over the magnetic disk 505. This movement causes the composite magnetic head 508 to perform a seek operation. The magnetic disk 505 is driven to rotate around a spindle axis of the spindle motor. When HDD 500 does not operate, magnetic disk 505 comes to a standstill.

As seen in FIG. 13, the composite magnetic head unit 508 may be a combination of an ILS (integrated lead suspension) (not shown), a read head 555, which comprises a GMR (giant magnetoresistive) sensor, and a write head 554, which comprises an induction-type converter. The read head 555 reads servo information when the head unit 508 reads data, writes data, or performs a seek operation. For a data read operation, the read head 555 also reads data between items of servo information. For a data write or data read, the actuator arm 506 pivots over the surface of the magnetic disk 505 during its rotation so that the composite magnetic head unit 508 performs a seek operation to scan for an arbitrary track on the magnetic disk 505. In this instance, the ABS (air bearing surface) of composite magnetic head unit 508, which faces the magnetic disk 505, receives a lift force due to an air current generated between the ABS and the magnetic disk 505. As a result, the composite magnetic head unit 508 constantly hovers a predetermined distance above the surface of the magnetic disk 505.

The read head 555 and write head 554, which constitute the composite magnetic head unit 508, are electrically connected to the head IC 552. The head IC 552 is mounted on a lateral surface of the pivot axis 507 of the actuator arm 506. One end of a flex cable 513 is connected to the head IC 552 to permit data exchange with the card 700. A connector 514 is attached to the remaining end of the flex cable 513 for connecting to the card 700. A temperature sensor 515 may be mounted on the upper surface of the connector 514 to measure the temperature inside the disk enclosure 400 (the ambient temperature for the magnetic disk 505).

The card 700 includes electronic circuits shown in FIG. 13, which control the operation of the actuator arm 506 and perform data read/write operations in relation to the magnetic disk 505. The card 700 controls the rotation of the magnetic disk 505 through a spindle/VCM driver 559 and drives the VCM coil 509 to control the seek operation of the actuator arm 506.

The HDD controller 550 transfers data between an external host (not shown) and the magnetic disk 505, generates a position error signal (PES) from servo data, and transmits the positional information about the composite magnetic head 508 to a read/write controller 551 and a microprocessor 558. In accordance with the control information from the microprocessor 558, the spindle/VCM driver 559 drives the VCM coil 509 to position the composite magnetic head 508 on the specified track. The positioning of the magnetic head unit 508 is determined by an IC position converter 556 in response to a signal from the magnetic head unit 508. The microprocessor 558 further interprets a command that is transmitted from an external host (not shown) through the HDD controller 550, and instructs the HDD controller 550 to perform a data read/write operation in relation to an address specified by the command. In accordance with the positional information about the composite magnetic head 508, which is generated by the HDD controller 550, the microprocessor 558 also transmits control information to the spindle/VCM driver 559 for the purpose of performing a seek operation to position composite magnetic head 508 on a specified track.

It is to be understood that the above description is intended to be illustrative and not restrictive. Many embodiments will be apparent to those of skill in the art upon reviewing the above description. The scope of the invention should, therefore, be determined not with reference to the above description, but instead should be determined with reference to the appended claims along with their full scope of equivalents.

What is claimed is:

1. A system for processing and storing data comprising:
a first processing module configured to receive data directed to the system, the data comprising a first portion and a second portion;
a second processing module configured to store the first portion of the data within a data storage device and remove the second portion of the data;
a third processing module configured to retrieve the first portion of the data from the data storage device, the first portion of the data being combined with filler data to form reconstituted data; and
a fourth processing module configured to send the reconstituted data to an output device.

2. The system of claim 1 wherein the data and the reconstituted data have identical file sizes.

3. The system of claim 1 wherein the data and the reconstituted data have identical data transfer rates.

4. The system of claim 1 wherein the data is in the format of a transport stream.

5. The system of claim 4 wherein the system includes a module that determines which portions of the transport stream to store based on packet identifier data of the individual packets within the transport stream.

6. The system of claim 5 wherein the filler data is located within packets that are identifiable based on the packet identifier data of the packets.

7. The system of claim 6 wherein the filler data is null data.

8. The system of claim 1 wherein the fourth processing module is configured to send the first portion of the data without the second portion of the data from the data storage device to the output device.

9. The system of claim 1 wherein the data storage device is a hard disk drive.

10. The system of claim 1 wherein the first portion of data is stored in a lossless manner.

11. The system of claim 1 wherein the first portion of data is stored in a lossy manner.

12. The system of claim 1 further comprising:
a fifth processing module configured to recognize the format of the data being received and selectively process the data based upon the format of the data being received

13. A data storage system comprising:
a hard disk drive;
and the system for processing and storing data as recited in claim 1;
wherein the hard disk drive is the data storage device; and
wherein the hard disk drive includes one or more of the first processing module, second processing module, third processing module, and fourth processing module.

14. The data storage system of claim 13 wherein the data storage system is a personal video recorder (PVR) device.

15. A host device used for media applications comprising:
the system for processing and storing data as recited in claim 1;
a host device controller configured to enable read/write access to the data storage device, the host device controller further configured to receive data stored on the data storage device and transmit the data to an output device connected or integrated with the host device; and
a communication bus configured to allow data to be transferred between the device controller and the storage device.

16. A file system for processing and storing content files comprising:
a first processing module configured to receive a content file in a first format directed to the file system, the content file comprising desired and undesired portions of the content file;
a second processing module configured to store the desired portion of the content file in a second format within a data storage device and remove the undesired portion of the content file;
a third processing module configured to retrieve the desired portion of the content file from the data storage device; the desired portion of the content file being retrieved in the second format; and
a fourth processing module configured to send the desired portion of the content file to an output device.

17. The file system of claim 16 wherein the third processing module is further configured to retrieve the requested portion of the content file in the first format from the data storage device, the undesired portion of the content file being replaced by null data.

18. A system for processing and storing content files comprising:
means for receiving data directed to the system, the data comprising a first portion and a second portion;
means for storing the first portion of the data within a data storage device while removing a second portion of the data;
means for retrieving the first portion of the data from the data storage device, the first portion of the data being combined with filler data to form reconstituted data; and
means for sending the reconstituted data to an output device.

19. The system of claim 18 further comprising:
means for sending the first portion of the data without the second portion of the data from the data storage device to the output device.

20. A computer readable storage medium storing a computer program in a system for processing and storing data, the computer program comprising:
code for receiving data in a first format directed to the system, the data comprising a first portion and a second portion;
code for storing the first portion of the data within a data storage device and removing a second portion of the data; and
code for retrieving the first portion of the data from the data storage device, the first portion of the data being combined with filler data to form reconstituted data.

21. The computer readable storage medium of claim 20 wherein the data and the reconstituted data have identical file sizes.

22. The computer readable storage medium of claim 20 wherein the data and the reconstituted data have identical data transfer rates.

23. The computer readable storage medium of claim 20 wherein the data is in the format of a transport stream.

24. The computer readable storage medium of claim 23 further comprising code for determining which portions of the transport stream to store based on packet identifier data of the individual packets within the transport stream.

25. The computer readable storage medium of claim 24 wherein the filler data is located within packets that are identifiable based on the packet identifier data of the packets.

26. The computer readable storage medium of claim 25 wherein the filler data is null data.

27. The computer readable storage medium of claim 20 further comprising code for sending the first portion of the data without the second portion of the data from the data storage device to an output device.
